(19) United States
(12) Patent Application Publication
(10) Pub. No.: US 2006/0046084 A1
(43) Pub. Date: Mar. 2, 2006

(54) Flexible polypropylene roofing membrane

(75) Inventors: Li-Ying Yang, Whippany, NY (US); Edward Nebesnak, Mine Hill, NJ (US)

Correspondence Address: GAF MATERIALS CORPORATION;Attn: William J. Davis, Esq., Legal Department, Building No. 8, 1361 Alps Road, Wayne, NJ, 07470, US

(73) Assignee: BUILDING MATERIALS INVESTMENT CORPORATION

(21) Appl. No.: 10/925,097

(22) Filed: Aug. 24, 2004

(51) Int. Cl. B32B 27/00; C08L 23/04

(52) U.S. Cl. 428/500; 525/240

(57) ABSTRACT

A thermoplastic polyolefin (TPO) roofing membrane is made by blending a new polypropylene based elastomer (PBE) or plastomer (PBP) and polyolefin copolymers. The new PBE or PBP offers superior flexibility over conventional polypropylene roofing membranes for easy installation. The new narrow molecular weight distribution and broad crystallinity distribution of the PBE or PBP results in excellent heat welding strength and wide heat welding windows of the said TPO membrane.

### FIELD OF THE INVENTION

The present invention relates to a building materials roofing membrane, and more particularly, to a flexible polypropylene roofing membrane that provides superior flexibility, heat welding strength, and wide heat welding windows.

### BACKGROUND OF THE INVENTION

A typical low-slope roofing system consists of three components: a structural deck, a thermal insulation barrier and a waterproofing membrane, which consists of reinforcing fibers or fabric sandwiched between two sheets of flexible matrix. The matrix material is either asphalt- or polymer-based. There are essentially two classes of polymer-based roofing membranes: thermosets and thermoplastics. Thermoplastics reversibly soften when heated, whereas thermosets do not. Thermoplastics encompass thermoplastic polyolefins (TPOs).

A typical TPO is a melt blend or reactor blend of a polyolefin plastic, typically a polypropylene polymer, with an olefin copolymer elastomer (OCE), typically an ethylene-propylene rubber (EPR) or an ethylene-propylene-diene rubber (EPDR). The polyolefin plastic imparts to the TPO the temperature resistance and the rigidity typical of that thermoplastic resin while the olefin copolymer elastomer imparts flexibility, resilience and toughness to the TPO.

A good roofing membrane has to be strong enough to withstand stresses, and flexible enough to accommodate deck movement. TPO membranes are flexible. The use of flexible membranes in roof constructions have heretofore been available within the last decade. Examples of commercially available flexible TPO membranes include SURE WELD™ (Carlisle Inc.), GENFLEX™ (Omnova Solutions, Inc), ULTRAPLY™ (Firestone Building Products) and EVERGUARD TPO™ (GAF). These membranes are fixed over a roof having insulation material placed thereon.

Problems with these membranes are that while they are flexible, they have a rigid feel, tend to hold their shape, and do not relax quickly. The stiffness characteristics affect the membrane installation process. As such, they are not favored by contractors because of their lack of ease of installation. Stiffer membranes are also a drawback in flashing applications where more flexibility is desired.

Reinforced TPO membranes are manufactured with a reinforcing scrim encapsulated between two layers of TPO compounds. Two TPO membranes are typically sealed by hot air heat-welding or seamed together using an adhesive. The hot air melts the polymer at the seam and the two strips of membrane become fused and bonded with gentle pressure. The welding window exists between cold welds (i.e., welds at temperatures that are not hot enough) and scorch/bum-through (i.e., welds at temperatures that are too hot). A TPO roofing membrane with a wide welding window, and fast welding speed is highly desirable. A wide welding window offers contactors easy installation as well as the opportunity to install in the cold weather because the membrane can be welded at low temperatures. Fast welding speed offers contractors a short installation time.

Another desirable characteristic of TPO membranes is the high heat seal strength. There are two sets of forces constantly working to damage the roofing seams. Wind uplift attempts to peel the seams apart. Building movement attempts to pull the seams apart. High seal strength provides high wind resistance for the roof and long life waterproofing. A conventional Ziegler-Natta catalyzed TPO has a bimodal or broad molecular weight distribution. The low molecular weight oligomers migrate to membrane surface preventing welding or deteriorating the heat seam strength. A TPO with a narrow molecular weight distribution eliminates surface blooming and provides high heat seal peel strength.

Accordingly, there is a need for a TPO roofing membrane with superior flexibility, heat welding strength, and wide heat welding windows.

### SUMMARY OF THE INVENTION

It is an object of the invention to provide a flexible roofing membrane having superior flexibility, excellent heat welding strength, and wide heat welding windows.

Another object of the invention is to provide a thermoplastic polyolefin roofing membrane is made by a blend of a polypropylene based plastomer (PBP) and elastomer (PBE) and polyolefins.

The new PBP or PBE offers superior flexibility over conventional polypropylene based copolymers and is suitable for TPO roofing applications.

The narrow molecular weight distribution and broad crystallinity distribution of the new PBE or PBP results in excellent heat welding strength and wide heat welding windows of the TPO membrane.

Accordingly, it is an object of the present invention to provide a flexible polypropylene roofing membrane with superior flexibility, excellent heat welding strength and wide heat welding windows.

Other objects, features, advantages of the invention shall become apparent as the description thereof proceeds when considered in connection with the accompanying examples.

### DETAILED DESCRIPTION OF THE INVENTION

As indicated above, the present invention provides a flexible TPO roofing membrane made by a blend of a new polypropylene based plastomer (PBP) or elastomer (PBE) and polyolefins that provides superior flexibility, excellent heat welding strength, and wide heat welding windows.

The PBE or PBP polymer composition of the present invention is propylene/alpha-olefin copolymers with semi-crystalline isotactic propylene segments.

The propylene based plastomers and elastomers of the present invention have a comonomer range of between about 5-15%, preferably about 12%. The comonomers are alpha-olefins. Most alpha-olefins include ethylene, butene, pentene, 4-methyl-1-pentene, hexane, heptene, octene, nonene etc. The PBE or PBP polymers of the present invention have a broad comonomer distribution that provides good blend compatibility with other olefin polymers and wide heat welding windows.

The PBE or PBP polymers of the present invention, on the other hand, have a narrow molecular weight distribution of 2-3. The molecular weight distribution is indicated by M_{w}/Mₙ (also referred to as polydispersity index or “PDI” or “MWD”). This is important as a broad molecular weight distribution of polymers produces a heterogeneous composition where there is high molecular weight at some sites and low molecular weight at others, resulting in less desirable mechanical and other properties. For such membranes with wide molecular weight distributions, the lower molecular weight particles float to the top and do not heat weld well together. The PBPs or PBEs of the present invention with a narrow MWD provide good mechanical and heat welding strength.

The plastomers and elastomers of the present invention are produced with a new non-metallocene catalyst in combination with Dow's INSITE™ technology. The production of these plastomers and elastomers is described more fully in “Press Release—Dow Unveils VERSIFY™ Plastomers and Elastomers—new technology generates unique performance combinations”, Dow Chemical Co., Feb. 12, 2004, pp. 1-3, which is incorporated by reference herein.

The plastomers and elastomers of the present invention have a unique molecular architecture. The unique structure differentiates the new PBPs or PBEs from typical Ziegler-Natta catalyst-based and metallocene catalyst-based copolymers of propylene. The broad crystallinity distribution results in broad melting behavior, and hence, a wide heat welding windows for TPO roofing membranes.

Suitable olefin polymers for use in the present invention include, but are not limited to, polypropylene impact copolymers, polypropylene random copolymers, polyethylene, polypropylene, ethylene/propylene copolymers, ethylene/1-butene copolymers, ethylene/1-hexene copolymers, ethylene/4-methyl-1-pentene copolymers, ethylene/styrene copolymers, ethylene/propylene/styrene copolymers, and ethylene/1-octene copolymers, isotactic polypropylene/1-butene copolymers, isotactic polypropylene/1-hexene copolymers, isotactic polypropylene/1-octene copolymers, terpolymers of ethylene, propylene and a non-conjugated diene, i.e., EPDM terpolymers, thermoplastic rubbers such as ethylene propylene rubber, metallocence polyolefins and the like.

Preferred polyolefins for use herein are ethylene-propylene copolymers, ethylene propylene rubber, and metallocence polyethylene.

The polypropylene based elastomers (PBE) or plastomers (PBP) of the present invention are present in the roofing membrane at a concentration of between about 25-74%. In one embodiment, the PBE is present in a concentration of 45%. In other embodiments, the PBE is present in a concentration of 65%. A mixture of elastomers and mixtures of elastomers and plastomers can be used. Optionally, a second elastomer is present in an amount from about 0% to about 30%. Ethylene-propylene rubbers (EPRs) are preferred and are present in the roofing membrane of the present invention at a concentration of about 0% to about 30%. In one embodiment, the PBE is present in an amount of 45% together with 15% of EPR. Optionally, metallocence polyethylene-ocentene copolymers (MPEs) are present in the roofing membrane of the present invention at a concentration of about 0-30%. In one embodiment, the PBE is present in an amount of 45% together with 10% of MPE.

The polyolefins of the present invention are present as polypropylene impact copolymer or polypropylene random copolymer. The polypropylene impact copolymers of the present invention are present in the roofing membrane at a concentration of about 0-60%, with an amount from about 30-50% being more typical. In one embodiment, the polypropylene impact copolymer is present at a concentration of 35%. In another embodiment, the polypropylene impact copolymer is present at a concentration of 40%.

The polypropylene random copolymers (RCPs) of the present invention are present in the roofing membrane at a concentration of 0-60%, with an amount from about 0-50% being more typical. In one embodiment, the polypropylene random copolymer is present in a concentration of 45%.

The flexible membranes of the present invention preferably have some degree of crystallinity. The crystalline character has two main roles. It modulates the level of toughness and the mechanical properties and it modifies the materials ability to withstand chemical stress. The propylene based plastomers and elastomers of the present invention have a crystallinity of up to 40%, and preferably a crystallinity range of about 3-30%.

The propylene based plastomers and elastomers of the present invention have a glass transition temperature (T_{g}) range of about −10 to −35° C. The T_{g} as used herein is the temperature above which a polymer becomes soft and pliable, and below which it becomes hard and glassy. The propylene based plastomers and elastomers of the present invention have a MFR range measured at 230° C. of between about 0.5 to about 25, preferably about 2, and a melt temperature range of about 50 to 120° C.

The propylene based plastomers and elastomers of the present invention have a preferred shore A hardness range of about 60 to about 90. However, it is understood that the shore A hardness range can be below 60 or greater than 90.

The propylene based plastomers and elastomers of the present invention have a flexural modulus range of about 500 to about 200,000 Psi, preferably about 2000 Psi.

The physical characteristics of the polypropylene based elastomer and polyolefin copolymers. The composition of the membranes of the present invention are depicted in Table 1 below:

TABLE 1

| | Polymers | | | | |
|---|---|---|---|---|---|
| | PBE | RCP | ICP | EPR | |
| | (Polypropylene | (Polypropylene | (Polypropylene | (Ethylene- | MPE |
| | based | random | impact | propylene | (metallocene |
| | elastomer) | copolymer) | copolymer) | rubber) | polyethylene) |
| Melt Index | 0.5-15 | 0.5-15 | 0.5-15 | 1-5 | 0.5-5 |
| Flex Modulus | 500-20,000 | 100,000-200,000 | 70,000-170,000 | | |
| (psi) | | | | | |
| Composition | 25-75% | 0-50% | 0-70% | 0-30% | 0-30% |
| Range in final | | | | | |
| compound | | | | | |
| Examples | Dow Versify | Dow 6D83K, | Basell Profax | Bayer | Dow Affinity |
| | DE2200, 2300, | 6D20 | 8623, | Buna EP | 8150, 8200, |
| | 2400.01 | | Huntsman | T2370P, | 8180, ENR |
| | | | 16S2, 17S2, | Exxon | 8556 |
| | | | 18S2, P6-005, | Vistalon | Exxon Exact |
| | | | Dow 6D82 | 919, JSR | 8201, 4049, |
| | | | | EP02P | 4056 |

The improved TPO membrane of the present invention has a number of advantages over previous TPOs. The TPO membrane of the present invention have superior flexibility. The membrane easily contours to uniquely shaped roofs, such as domes, sawtooth roofing and barrel roofs. Superior flexibility allows for the accommodation of normal structural movement of a building without splitting or cracking. Additionally, the membrane remains flexible without the need for plasticizers which can break down, causing the roof to become brittle or shrink. The wider welding window results in fast, economical installation, and high strength.

The flexible polypropylene membranes of the present invention are in standard thicknesses of 4 to 200 mils, and more preferably from 15-100 mils.

Other ingredients in addition to polymers in the TPO roofing membranes include, but are not limited to: fillers, color pigments, fire retardants, antioxidants, UV and thermal stabilizers and processing aids.

The TPO membranes of the present invention may be any color such as white, grey, or beige. It may also have predetermined printed or embossed designs on its top surface.

The TPO polymers of the present invention may be made either by precompounding or by in-situ compounding using polymer-manufacturing processes such as Banbury mixing or twin screw extrusion. After further mixing with other additives, these TPO polymers are then formed into roofing materials.

Membrane materials according to the invention may have surprising advantages, including superior durability, wind uplift performance, fire spread performance, puncture resistance, dimensional stability, thermal stability and solvent resistance.

The roofing membrane of the present invention may be fixed over the base roofing by any means known in the art such as via adhesive material, ballasted material, spot bonding, or mechanical spot fastening.

The present invention is explained in greater detail by reference to the following examples, but the present invention should not be construed as limited thereto.

### EXAMPLES

Standard

Cap (top) and base (bottom) sheets (layers) of a standard single ply reinforcement polyolefin roofing membranes was made of 100 parts of reactive grade polypropylene copolymers, including conventional ingredients, such as 0-80 parts of fire retardant, 0-5 parts UV and thermal stabilizers, 0-15 parts carbon black, titanium dioxide and calcium carbonate, as is well known in the art. The ingredients were mixed in an extruder at 200° C. and sheeted to a thickness of about 15-50 mils. A reinforcement polyester scrim then was inserted between the top and bottom sheets, and the three layers were pressed into a 30-100 mil reinforced single ply membrane. The standard membrane then was tested for the physical and welding properties. Tensile strength, low temperature flexibility, peel and seal strength were determined.

### Invention Example 1

The 100 parts of TPO polymers are a blend of 65% PBE and 35% polypropylene impact copolymer. Other ingredients in top and bottom sheets are the same ingredients as described in the Standard Example. Then the compositions were mixed in an extruder at 200° C. and sheeted to thicknesses of about 15-50 mils. A reinforcement scrim was then inserted between the top and bottom sheets and the three layers were pressed into a 30-100 mil single ply reinforced membrane. The resulting 45-mil membrane was tested for physical and welding properties.

### Invention Example 2

The 100 parts of TPO polymers are a blend of 45% PBE and 45% polypropylene random copolymer and 10% MPE. Other ingredients in top and bottom sheets are the same ingredients as described in the Standard Example.

### Invention Example 3

The 100 parts of TPO polymers are a blend of 45% PBE and 40% polypropylene impact copolymer and 15% ethylene-propylene rubber. Other ingredients in top and bottom sheets are the same ingredients as described in the Standard Example.

Test Results

The results show that material failure of the flexible TPO membranes of the present invention can be excluded. Additionally, superior welding of the seams was proven. The physical and welding properties of the membranes of Invention Examples 1-3, and the Standard Example are given in Table 2 below.

TABLE 2

| Physical | ASTM Test | Standard | Invention | Invention |
|---|---|---|---|---|
| Properties | Methods | Example | Example 1 | Example 2 |
| Breaking | D751 | 274 | 277 | 292 |
| Strength | | | | |
| (MD), lbf | | | | |
| 180° Heat Seam | D413 | 64 | 76 | 84 |
| Peel strength at | | | | |
| 1148° F., 16 FPM | | | | |
| 180° Heat Seam | D413 | 58 | 74 | 75 |
| Peel strength at | | | | |
| 600° F., 10 FPM | | | | |

MD = machine direction

Results in Table 2 showed significant increase (19-31%) of heat seam peel strength with the new invented TPO membrane over the standard TPO membrane at wide welding conditions.

TABLE 3

| Physical | ASTM Test | Standard | Invention |
|---|---|---|---|
| Properties | Methods | Example | Example 3 |
| Breaking | D751 | 274 | 277 |
| Strength (MD), | | | |
| lbf | | | |
| Flexural | D790 | 313 | 190 |
| Modulus (MD), | | | |
| MPa at 20° C. | | | |
| Flexural | D790 | 521 | 420 |
| Modulus (MD), | | | |
| MPa at 0° C. | | | |
| 180° Heat Seam | D413 | 23 | 40 |
| Peel Strength at | | (seam failed) | |
| 600° F. and 12 | | | |
| FPM | | | |
| Bond Strength to | D413 | 10 | 18 |
| Plywood (lb/in) | | | |
| w/water based | | | |
| adhesive | | | |

Results in Table 3 showed significantly lower modulus (i.e., 20-40%) hence more compliable for roof detailing application. The new TPO has wider welding window at low welding temperature of 600° F. Seam strength was measured in peel mode. When membranes were welded at 600° F. and 12 FPM, the standard membrane showed seam failure (too cold) while the invented TPO (Example 3) had twice seal strength as standard membrane. The bond strength with water-based adhesive is also superior for the new invented TPO membrane. The PBE based TPO gives overall improved membrane performance.

Superior aging performance may be demonstrated by accelerated aging tests such as, but not limited to, thermal aging; artificial weathering with UV irradiation; behavior in hot water; hot-cold cycles; behavior in aggressive fluids (e.g., chemicals); resistance to microorganisms (e.g. fungus/algae).

It is understood that the flexible polypropylene roofing membranes of the present invention comply with the ASTM D-6878.

The flexible polypropylene membranes of the present invention may be installed in the same manner as other flexible membranes including but not limited to mechanically fastened, adhered, stone or paver ballasted, or installed as a vented roofing system.

The membranes of the present invention are typically installed using mechanical fasteners and plates placed along the edge sheet and fastened through the membrane and into the roof decking. Adjoining sheets of flexible polypropylene membrane are overlapped, covering the fasteners and plates, and preferably joined together with a minimum 40 mm wide hot air weld. The membrane may also be fully adhered or self adhered to an insulation or deck material using an adhesive. Insulation is typically secured to the deck with mechanical fasteners and the flexible membrane is adhered to the insulation.

Further the membranes can be used in most commercial applications and installed on flat, low-sloped or steep-sloped substrates.

It is to be understood that the membranes may be reinforced with any type of scrim including, but not limited to, polyester, fiberglass, fiberglass reinforced polyester, polypropylene, woven or non-woven fabrics (e.g. Nylon) or combinations thereof. Preferred scrims are fiberglass and/or polyester.

The flexible polypropylene membranes of the present invention may be made with additional reinforcement on the back of the bottom TPO sheet. The reinforcement includes, but not limited to, polyester, polypropylene and Nylon fleece, and/or a glass fiber mat. Further, it is understood that the membranes of the present invention may be non-reinforced or reinforced with polyester or other synthetic materials.

It is to be understood that a surface layer of the top and/or bottom of the membrane of the present invention may be textured with various patterns. Texture increases the surface area of the membrane, reduces glare and makes the membrane surface less slippery. Examples of texture designs include, but are not limited to, a polyhedron with a polygonal base and triangular faces meeting in a common vertex, such as a pyramidal base; a cone configuration having a circular or ellipsoidal configurations; and random pattern configurations. Mechanical surface embossing of roofing membranes is disclosed in U.S. patent application Ser. No. 10/798,595 filed Mar. 11, 2004 which is herein incorporated by reference in its entirety.

While there is shown and described herein certain specific compositions embodying the invention, it will be manifest to those skilled in the art that various modifications may be made without departing from the spirit and scope of the underlying inventive concept and that the same is not limited to the particular forms herein described except insofar as indicated by the scope of the appended claims.

What is claimed is:

1. A flexible roofing membrane comprising: a blend of propylene/alpha-olefin copolymers with semi-crystalline isotactic propylene segments and polyolefin copolymers.

2. The flexible roofing membrane of claim 1, wherein said propylene/alpha-olefin copolymers with semi-crystalline isotactic propylene segments are selected from the group consisting of polypropylene based elastomers (PBE), polypropylene based plastomers (PBP), and combination thereof.

3. The flexible roofing membrane of claim 1, wherein said alpha-olefins are selected from the group consisting of ethylene, butene, pentene, 4-methyl-1-pentene, hexane, heptene, octane and nonene.

4. The flexible roofing membrane of claim 1, wherein said polyolefin copolymers are selected from the group consisting of: polypropylene impact copolymers, polypropylene random copolymers, polyethylene, polypropylene, ethylene/propylene copolymers, ethylene/1-butene copolymers, ethylene/1-hexene copolymers, ethylene/4-methyl-1-pentene copolymers, ethylene/styrene copolymers, ethylene/propylene/styrene copolymers, ethylene/1-octene copolymers, isotactic polypropylene/1-butene copolymers, isotactic polypropylene/1-hexene copolymers, isotactic polypropylene/1-octene copolymers, terpolymers of ethylene, propylene and a non-conjugated diene, terpolymers, thermoplastic rubbers, ethylene propylene rubbers (EPRs), and metallocence polyolefins.

5. The flexible roofing membrane of claim 1, wherein said blend of propylene/alpha-olefin copolymers with semi-crystalline isotactic propylene segments comprises 65% PBE or PBP and said polyolefin comprises 35% polypropylene impact copolymer.

6. The flexible roofing membrane of claim 1, wherein said blend of propylene/alpha-olefin copolymers with semi-crystalline isotactic propylene segments and polyolefin copolymers comprises 45% PBE or PBP, 45% RCP, and 10% MPE.

7. The flexible roofing membrane of claim 1, wherein said blend of propylene/alpha-olefin copolymers with semi-crystalline isotactic propylene segments and polyolefin copolymers comprises 45% PBE or PBP, 40% polypropylene impact copolymer, and 15% ethylene-propylene rubber.

8. The flexible roofing membrane of claim 2, wherein said PBE or PBP has a molecular weight distribution of between about 2 to about 3.

9. The flexible roofing membrane of claim 2, wherein said PBE or PBP is present at a concentration of between about 25% to about 75%.

10. The flexible roofing membrane of claim 4, wherein said polypropylene impact copolymers are present at a concentration of about 0% to about 70%.

11. The flexible roofing membrane of claim 4, wherein said metallocence polyolefins are MPEs.

12. The flexible roofing membrane of claim 11, wherein said MPEs are present at a concentration of about 0% to about 30%.

13. The flexible roofing membrane of claim 4, wherein said EPRs are present at a concentration of about 0% to about 30%.

14. The flexible roofing membrane of claim 4, wherein said RCPs are present at a concentration of about 0% to about 50%.

15. The flexible roofing membrane of claim 2, wherein said PBEs and PBPs have a MFR range measured at 230° C. of between about 0.5 to about 25.

16. The flexible roofing membrane of claim 2, wherein said PBEs and PBPs have a MFR of about 2.

17. The flexible roofing membrane of claim 2, wherein said PBEs and PBPs have a comonomer range of between about 5% to about 15%.

18. The flexible roofing membrane of claim 2, wherein said PBEs and PBPs have a comonomer range of about 12%.

19. The flexible roofing membrane of claim 2, wherein said PBEs and PBPs have a crystallinity of about 3% to about 40%.

20. The flexible roofing membrane of claim 2, wherein said PBEs and PBPs have a glass transition temperature range of about −10 to about −35° C.

21. The flexible roofing membrane of claim 2, wherein said PBEs and PBPs have a melt temperature range of about 50° to about 120° C.

22. The flexible roofing membrane of claim 2, wherein said PBEs or PBPs have a shore A hardness range of about 60 to about 90.

23. The flexible roofing membrane of claim 2, wherein said PBEs or PBPs have a flexural modulus range of about 500 to about 200,000 Psi.

24. The flexible roofing membrane of claim 2, wherein said PBEs or PBPs have a flexural modulus range of about 2,000 Psi.

25. The flexible roofing membrane of claim 1, further comprising a reinforcement scrim sandwiched between a top layer and a bottom layer of said flexible roofing membrane.

26. The flexible roofing membrane of claim 25, wherein said reinforcement scrim is of a material selected from the group consisting of polyester, fiberglass, fiberglass reinforced polyester, polypropylene, woven fabrics, non-woven fabrics, and combinations thereof.

27. The flexible roofing membrane of claim 1, wherein said membrane may be non-reinforced or reinforced.

28. The flexible roofing membrane of claim 1, wherein said membrane is installed by a process selected from the group consisting of mechanically fastened, adhered, stone ballasted, paver ballasted, and installed as a vented roofing system.

29. The flexible roofing membrane of claim 1, having a thickness of about 15 to about 100 mils.

30. The flexible roofing membrane of claim 1, wherein a surface layer is textured with a design.
